(19) United States
(12) Patent Application Publication
(10) Pub. No.: US 2026/0237387 A1
(43) Pub. Date: Aug. 13, 2026

(54) VOICE ASSISTANT PERSISTENCE ACROSS MULTIPLE NETWORK MICROPHONE DEVICES

(71) Applicant: Sonos, Inc., Goleta, CA (US)

(72) Inventors: Connor Kristopher Smith, New Hudson, MI (US); Paul Bates, Seattle, WA (US)

(21) Appl. No.: 19/408,105

(22) Filed: Dec. 3, 2025

Related U.S. Application Data
(63) Continuation of application No. 18/461,430, filed on Sep. 5, 2023, now Pat. No. 12,518,756.
Application No. 18/461,430 is a continuation of application No. 17/305,920, filed on Jul. 16, 2021, now Pat. No. 11,798,553.
Application No. 17/305,920 is a continuation of application No. 16/402,617, filed on May 3, 2019, now Pat. No. 11,120,794.

(51) Int. Cl. G10L 15/22; G10L 15/08; G10L 15/32; H04R 1/32

(52) U.S. Cl. CPC G10L 15/22; G10L 15/08; G10L 15/32; H04R 1/326; G10L 2015/088; G10L 2015/223; G10L 2015/227

(57) ABSTRACT

Systems and methods for maintaining voice assistant persistence across multiple network microphone devices are described. In one example, first and second NMDs each identify a wake word based on detected sound, and are each transitioned from an inactive state to an active state in which the NMD captures and transmits sound data over a network interface. The first NMD is selected over the second NMD to output a first response, and both NMDs remain in the active state to further capture and transmit sound data. After further capturing and transmitting of sound data, the second NMD is selected over the first NMD to output a second response. After a predetermined time, one or both of the NMDs are transitioned back to the inactive state. The selection of one NMD over another for outputting a response can be based at least in part on user location information.

### CROSS-REFERENCE TO RELATED APPLICATIONS

This application is a continuation of U.S. patent application Ser. No. 18/461,430, filed Sep. 5, 2023, which is a continuation of U.S. patent application Ser. No. 17/305,920, filed Jul. 16, 2021, now U.S. Pat. No. 11,798,553, which is a continuation of U.S. patent application Ser. No. 16/402,617, filed May 3, 2019, now U.S. Pat. No. 11,120,794, each of which is incorporated herein by reference in its entirety.

### TECHNICAL FIELD

The present technology relates to consumer goods and, more particularly, to methods, systems, products, features, services, and other elements directed to voice-controllable media playback systems or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The SONOS Wireless HiFi System enables people to experience music from many sources via one or more networked playback devices. Through a software control application installed on a smartphone, tablet, or computer, one can play what he or she wants in any room that has a networked playback device. Additionally, using a controller, for example, different songs can be streamed to each room that has a playback device, rooms can be grouped together for synchronous playback, or the same song can be heard in all rooms synchronously.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the playback device of FIG. 2A.

FIGS. 3A-3E are diagrams showing example playback device configurations in accordance with aspects of the disclosure.

FIG. 4A is a functional block diagram of an example controller device in accordance with aspects of the disclosure.

FIGS. 4B and 4C are controller interfaces in accordance with aspects of the disclosure.

FIG. 5 is a functional block diagram of certain components of an example network microphone device in accordance with aspects of the disclosure.

FIG. 6A is a diagram of an example voice input.

FIG. 6B is a graph depicting an example sound specimen in accordance with aspects of the disclosure.

FIGS. 7-9 are signal line diagrams illustrating example data flows in accordance with aspects of the disclosure.

FIG. 10 is a schematic view of a user navigating an environment having a media playback system configured in accordance with aspects of the disclosure.

FIG. 11 is a flow diagram of a method for maintaining voice assistant persistence across multiple network microphone devices in accordance with aspects of the disclosure.

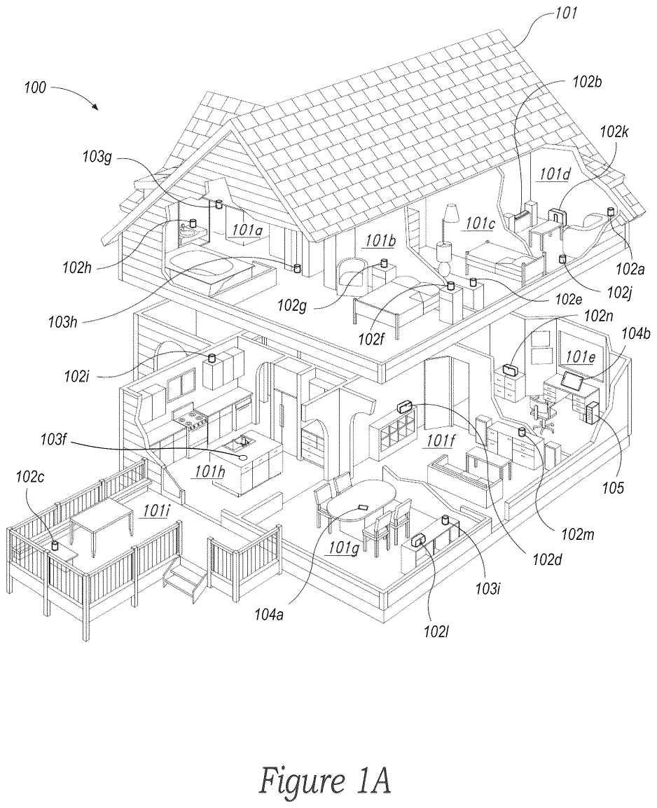

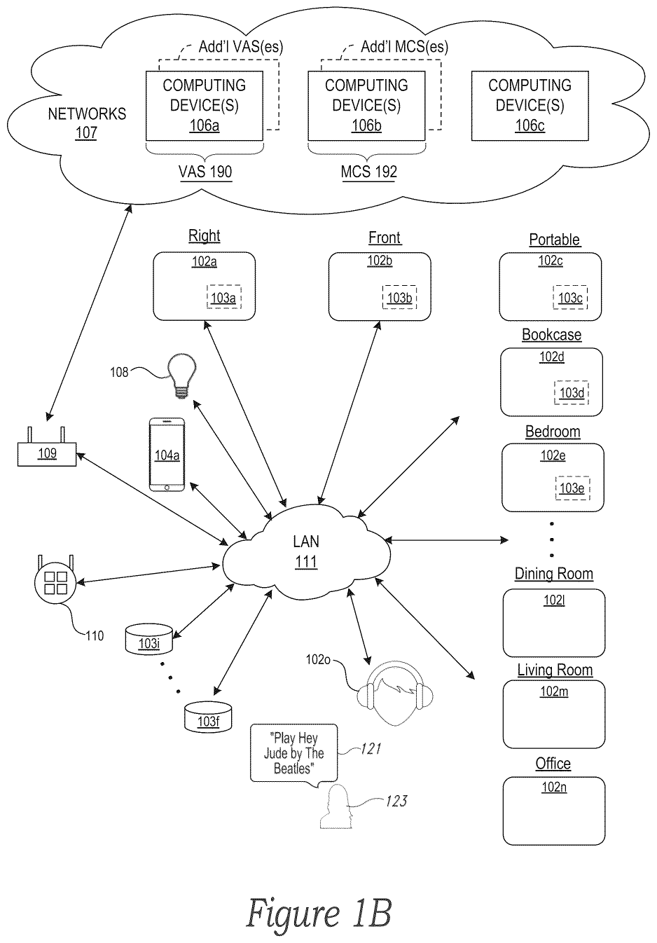

The drawings are for purposes of illustrating example embodiments, but it should be understood that the inventions are not limited to the arrangements and instrumentality shown in the drawings. In the drawings, identical reference numbers identify at least generally similar elements. To facilitate the discussion of any particular element, the most significant digit or digits of any reference number refers to the Figure in which that element is first introduced. For example, element 103a is first introduced and discussed with reference to FIG. 1A.

### DETAILED DESCRIPTION

### I. Overview

Voice control can be beneficial in a “smart” home that includes smart appliances and devices that are connected to a communication network, such as wireless audio playback devices, illumination devices, and home-automation devices (e.g., thermostats, door locks, etc.). In some implementations, network microphone devices may be used to control smart home devices.

A network microphone device (“NMD”) is a networked computing device that typically includes an arrangement of microphones, such as a microphone array, that is configured to detect sounds present in the NMD's environment. The detected sound may include a person's speech mixed with background noise (e.g., music being output by a playback device or other ambient noise). In practice, an NMD typically filters detected sound to remove the background noise from the person's speech to facilitate identifying whether the speech contains a voice input indicative of voice control. If so, the NMD may take action based on such a voice input.

An NMD often employs a wake-word engine, which is typically onboard the NMD, to identify whether sound detected by the NMD contains a voice input that includes a particular wake word. The wake-word engine may be configured to identify (i.e., “spot”) a particular wake word using one or more identification algorithms. This wake-word identification process is commonly referred to as “keyword spotting.” In practice, to help facilitate keyword spotting, the NMD may buffer sound detected by a microphone of the NMD and then use the wake-word engine to process that buffered sound to determine whether a wake word is present.

When a wake-word engine spots a wake word in detected sound, the NMD may determine that a wake-word event (i.e., a “wake-word trigger”) has occurred, which indicates that the NMD has detected sound that includes a potential voice input. The occurrence of the wake-word event typically causes the NMD to perform additional processes involving the detected sound. In some implementations, these additional processes may include outputting an alert (e.g., an audible chime and/or a light indicator) indicating that a wake word has been identified and extracting detected-sound data from a buffer, among other possible additional processes. Extracting the detected sound may include reading out and packaging a stream of the detected-sound according to a particular format and transmitting the packaged sound-data to an appropriate VAS for interpretation.

In turn, the VAS corresponding to the wake word that was identified by the wake-word engine receives the transmitted sound data from the NMD over a communication network. A VAS traditionally takes the form of a remote service implemented using one or more cloud servers configured to process voice inputs (e.g., AMAZON's ALEXA, APPLE's SIRI, MICROSOFT's CORTANA, GOOGLE'S ASSISTANT, etc.). In some instances, certain components and functionality of the VAS may be distributed across local and remote devices. Additionally, or alternatively, a VAS may take the form of a local service implemented at an NMD or a media playback system comprising the NMD such that a voice input or certain types of voice input (e.g., rudimentary commands) are processed locally without intervention from a remote VAS.

In any case, when a VAS receives detected-sound data, the VAS will typically process this data, which involves identifying the voice input and determining an intent of words captured in the voice input. The VAS may then provide a response back to the NMD with some instruction according to the determined intent. Based on that instruction, the NMD may cause one or more smart devices to perform an action. For example, in accordance with an instruction from a VAS, an NMD may cause a playback device to play a particular song or an illumination device to turn on/off, among other examples. In some cases, an NMD, or a media system with NMDs (e.g., a media playback system with NMD-equipped playback devices) may be configured to interact with multiple VASes. In practice, the NMD may select one VAS over another based on the particular wake word identified in the sound detected by the NMD.

In some implementations, a playback device that is configured to be part of a networked media playback system may include components and functionality of an NMD (i.e., the playback device is “NMD-equipped”). In this respect, such a playback device may include a microphone that is configured to detect sounds present in the playback device's environment, such as people speaking, audio being output by the playback device itself or another playback device that is nearby, or other ambient noises, and may also include components for buffering detected sound to facilitate wake-word identification.

Some NMD-equipped playback devices may include an internal power source (e.g., a rechargeable battery) that allows the playback device to operate without being physically connected to a wall electrical outlet or the like. In this regard, such a playback device may be referred to herein as a “portable playback device.” On the other hand, playback devices that are configured to rely on power from a wall electrical outlet or the like may be referred to herein as “stationary playback devices,” although such devices may in fact be moved around a home or other environment. In practice, a person might often take a portable playback device to and from a home or other environment in which one or more stationary playback devices remain.

In some cases, multiple voice services are configured for the NMD, or a system of NMDs (e.g., a media playback system of playback devices). One or more services can be configured during a set-up procedure, and additional voice services can be configured for the system later on. As such, the NMD acts as an interface with multiple voice services, perhaps alleviating a need to have an NMD from each of the voice services to interact with the respective voice services. Yet further, the NMD can operate in concert with service-specific NMDs present in a household to process a given voice command.

Where two or more voice services are configured for the NMD, a particular voice service can be invoked by utterance of a wake word corresponding to the particular voice service. For instance, in querying AMAZON, a user might speak the wake word “Alexa” followed by a voice command. Other examples include “Ok, Google” for querying GOOGLE and “Hey, Siri” for querying APPLE.

In some cases, a generic wake word can be used to indicate a voice input to an NMD. In some cases, this is a manufacturer-specific wake word rather than a wake word tied to any particular voice service (e.g., “Hey, Sonos” where the NMD is a SONOS playback device). Given such a wake word, the NMD can identify a particular voice service to process the request. For instance, if the voice input following the wake word is related to a particular type of command (e.g., music playback), then the voice input is sent to a particular voice service associated with that type of command (e.g. a streaming music service having voice command capabilities).

In some instances, an environment may have multiple NMDs disposed in various locations. For example, a user may have a first NMD in the kitchen, a second NMD in the living room, etc. Many voice interactions involve extended interactions, for example multi-turn conversations with a VAS. As such, the interaction may span a user's movement from a first position adjacent to the first NMD to a second position adjacent to the second NMD. As a result, the first NMD may receive a lower volume and/or quality of detected sound from the user's speech as the user moves away from the first NMD, and accordingly the VAS may have more difficulty discerning the user's intent. Meanwhile, the second NMD may receive higher volume and/or quality of detected sound from the user's speech as the user moves closer to the second NMD. Yet if the VAS remains solely in communication with the first NMD (e.g., receiving sound data from the first NMD, and providing responses to be output via the first NMD), the media playback system may be unable to take advantage of the second NMD's comparatively better sound data. In some cases, this can lead to abrupt interruptions or dropped conversations as the user moves about the environment. Accordingly, it would be beneficial to enable a user to continue a seamless interaction with a VAS even when leaving the vicinity of one NMD and entering the vicinity of another NMD. As such, it can be useful to coordinate sound detection, data transmission, and response output between two or more NMDs in a shared or overlapping environment.

In some embodiments, for example, a user may speak a wake word and a voice utterance (e.g., a command) in the vicinity of multiple NMDs. Two or more of the NMDs may detect sound based on the user's speech and identify the wake word therein. Each of these NMDs may then transition from an inactive state to an active state. In the inactive state, the NMD listens for a wake word in detected sound but does not transmit any data based on the detected sound. Once transitioned to the active state, the NMD is readied to capture sound data corresponding to the detected sound. In the active state, the NMD may continuously, periodically, or aperiodically transmit the sound data over a network interface, either over a local network (e.g., to other local devices) or over a wide area network (e.g., to remote computing devices associated with a VAS). In some embodiments, while multiple NMDs can be simultaneously capturing and transmitting sound data, only one of the NMDs is selected to output responses (e.g., providing a voice response from a VAS or other output). The particular NMD can be selected to provide output based on user location, such that the NMD nearest the user outputs the response. As the user moves about the environment, the selected NMD can be updated, such that different NMDs can output responses to the user as the user's location changes. In some embodiments, some or all of the NMDs can transition from the active state back to the inactive state after a predetermined time, for example a predetermined period of time after the last response output from that particular NMD. Accordingly, as described in more detail below, multiple NMDs may coordinate responsibility for voice control interactions to deliver an improved user experience.

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

### II. Example Operating Environment

FIGS. 1A and 1B illustrate an example configuration of a media playback system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-102i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A). In embodiments described below, one or more of the various playback devices 102 may be configured as portable playback devices, while others may be configured as stationary playback devices. For example, the headphones 1020 (FIG. 1B) are a portable playback device, while the playback device 102d on the bookcase may be a stationary device. As another example, the playback device 102c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices 102-104 and/or other network devices of the MPS 100 may be coupled to one another via point-to-point connections and/or over other connections, which may be wired and/or wireless, via a LAN 111 including a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related embodiment, the Left playback device 102j may communicate with other network devices, such as the playback device 102b, which may be designated as the “Front” device, via a point-to-point connection and/or other connections via the LAN 111.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a VAS and at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the playback devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 1021, 102m, and 102n, which are named “Bedroom,” “Dining Room,” “Living Room,” and “Office,” respectively. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the LAN 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the media playback system 100 may exchange data via communication paths as described herein and/or using a metadata exchange channel as described in U.S. application Ser. No. 15/438,749 filed Feb. 21, 2017, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. application Ser. No. 15/438,749.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 1021, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. patent application Ser. No. 15/438,749.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the LAN 111 (FIG. 1B) may be eliminated and the single playback device 102 and/or the single NMD 103 may communicate directly with the remote computing devices 106a-d. In some embodiments, a telecommunication network (e.g., an LTE network, a 5G network, etc.) may communicate with the various playback, network microphone, and/or controller devices 102-104 independent of a LAN.

### a. Example Playback & Network Microphone Devices

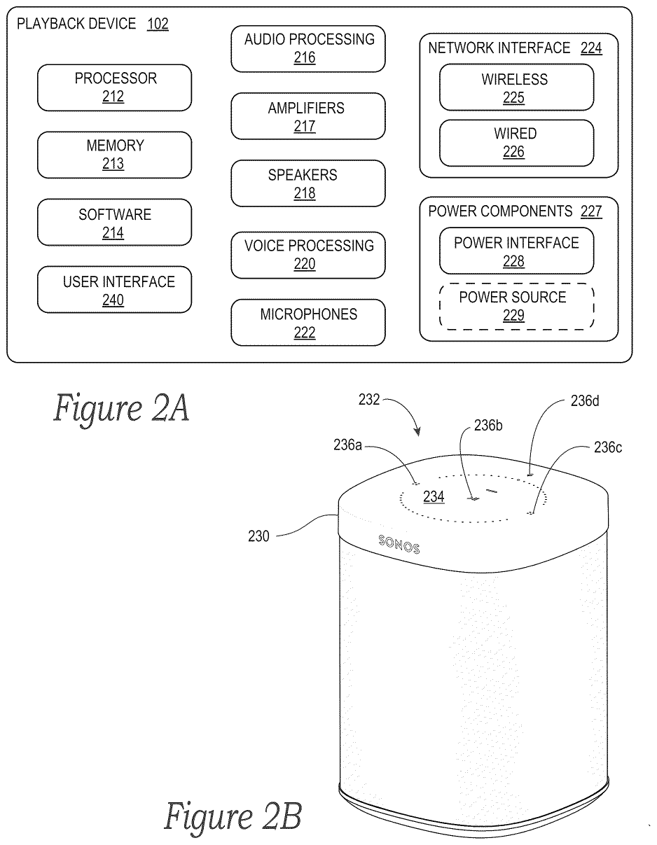

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the playback device to external speakers. In certain embodiments, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A include both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

In some implementations, the voice-processing components 220 may detect and store a user's voice profile, which may be associated with a user account of the MPS 100. For example, voice profiles may be stored as and/or compared to variables stored in a set of command information or data table. The voice profile may include aspects of the tone or frequency of a user's voice and/or other unique aspects of the user's voice, such as those described in previously-referenced U.S. patent application Ser. No. 15/438,749.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The playback device 102 further includes a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the playback device 102.

By way of illustration, SONOS, Inc. presently offers (or has offered) for sale certain playback devices that may implement certain of the embodiments disclosed herein, including a “PLAY: 1,” “PLAY: 3,” “PLAY: 5,” “PLAYBAR,” “CONNECT: AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIG. 2A or 2B or to the SONOS product offerings. For example, a playback device may include, or otherwise take the form of, a wired or wireless headphone set, which may operate as a part of the media playback system 100 via a network interface or the like. In another example, a playback device may include or interact with a docking station for personal mobile media playback devices. In yet another example, a playback device may be integral to another device or component such as a television, a lighting fixture, or some other device for indoor or outdoor use.

### v. Example Playback Device Configurations

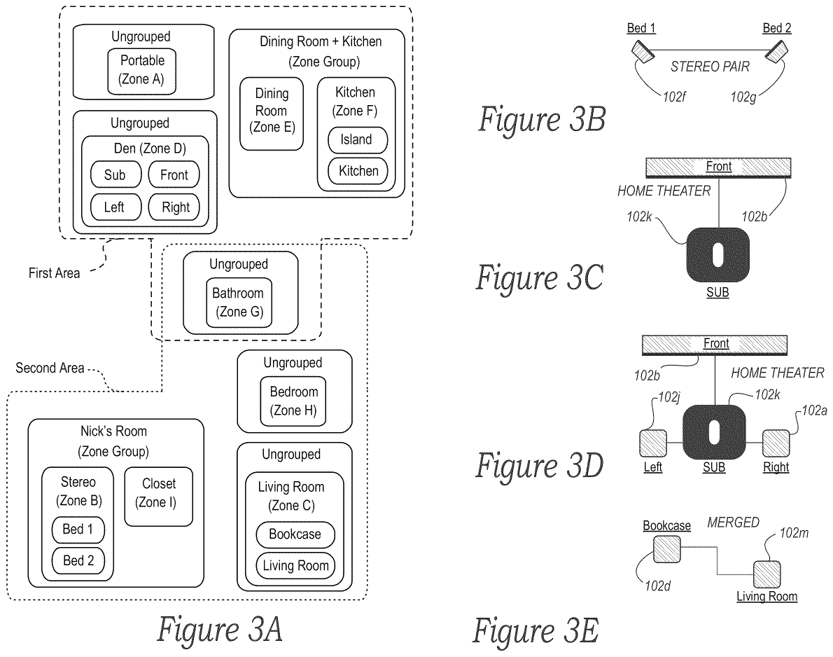

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.” In various embodiments, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the playback devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in previously referenced U.S. patent application Ser. No. 15/438,749. In some embodiments, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room +Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the media playback system 100, which may be shared from time to time among the devices so that one or more of the devices have the most recent data associated with the system.

In some embodiments, the memory 213 of the playback device 102 may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room +Kitchen group and that devices 103f and 102i are bonded. Identifiers associated with the Kitchen may indicate the same or similar information by virtue of the Kitchen being part of the Dining Room +Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In embodiments described below, the memory 213 is configured to store a set of command data for selecting a particular VAS when processing voice inputs.

During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone. For instance, the user may be in the Office zone where the playback device 102n is playing the same hip-hop music that is being playing by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 1021 may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

### c. Example Controller Devices

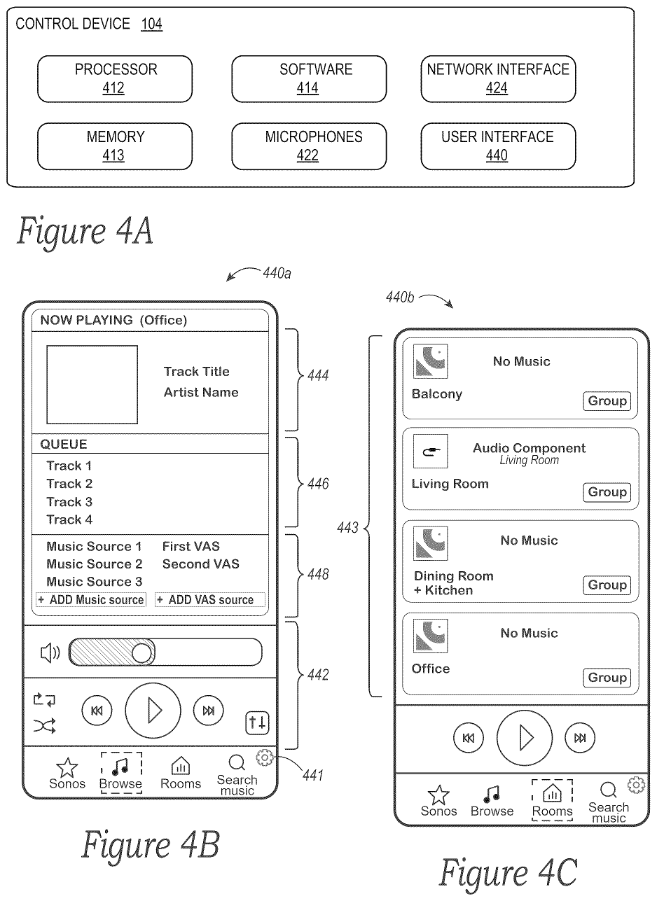

FIG. 4A is a functional block diagram illustrating certain aspects of a selected one of the controller devices 104 of the MPS 100 of FIG. 1A. Such controller devices may also be referred to herein as a “control device” or “controller.” The controller device shown in FIG. 4A may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

As shown in FIG. 4A, the controller device 104 also includes a user interface 440 that is generally configured to facilitate user access and control of the MPS 100. The user interface 440 may include a touch-screen display or other physical interface configured to provide various graphical controller interfaces, such as the controller interfaces 440a and 440b shown in FIGS. 4B and 4C. Referring to FIGS. 4B and 4C together, the controller interfaces 440a and 440b includes a playback control region 442, a playback zone region 443, a playback status region 444, a playback queue region 446, and a sources region 448. The user interface as shown is just one example of an interface that may be provided on a network device, such as the controller device shown in FIG. 4A, and accessed by users to control a media playback system, such as the MPS 100. Other user interfaces of varying formats, styles, and interactive sequences may alternatively be implemented on one or more network devices to provide comparable control access to a media playback system.

The playback control region 442 (FIG. 4B) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The playback control region 442 may also include selectable icons that, when selected, modify equalization settings and/or playback volume, among other possibilities.

The playback zone region 443 (FIG. 4C) may include representations of playback zones within the MPS 100. The playback zones regions 443 may also include a representation of zone groups, such as the Dining Room+Kitchen zone group, as shown. In some embodiments, the graphical representations of playback zones may be selectable to bring up additional selectable icons to manage or configure the playback zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 443 (FIG. 4C) may be dynamically updated as playback zone or zone group configurations are modified.

The playback status region 444 (FIG. 4B) may include graphical representations of audio content that is presently being played, previously played, or scheduled to play next in the selected playback zone or zone group. The selected playback zone or zone group may be visually distinguished on a controller interface, such as within the playback zone region 443 and/or the playback status region 444. The graphical representations may include track title, artist name, album name, album year, track length, and/or other relevant information that may be useful for the user to know when controlling the MPS 100 via a controller interface.

The playback queue region 446 may include graphical representations of audio content in a playback queue associated with the selected playback zone or zone group. In some embodiments, each playback zone or zone group may be associated with a playback queue comprising information corresponding to zero or more audio items for playback by the playback zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 4B and 4C, the graphical representations of audio content in the playback queue region 446 (FIG. 4B) may include track titles, artist names, track lengths, and/or other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 448 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to one or both of the NMDs 102a and 102b in the Living Room shown in FIG. 1A, and a second VAS to the NMD 103f in the Kitchen. Other examples are possible.

### d. Example Audio Content Sources

The audio sources in the sources region 448 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some embodiments audio content may be provided by one or more media content services.

Example audio content sources may include a memory of one or more playback devices in a media playback system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media playback system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

### e. Example Network Microphone Devices

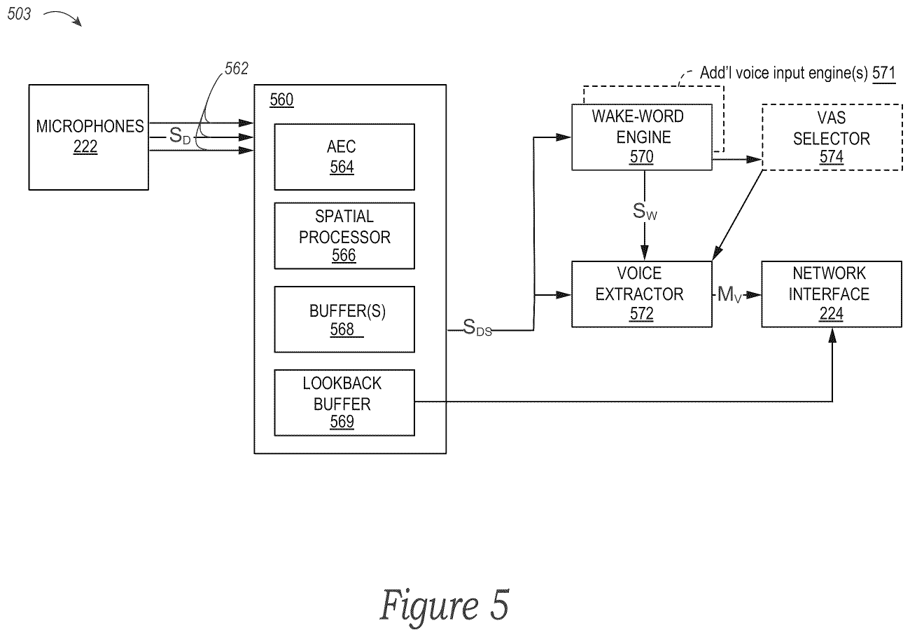

FIG. 5 is a functional block diagram showing an NMD 503 configured in accordance with embodiments of the disclosure. The NMD 503 includes voice capture components (“VCC”, or collectively “voice processor 560”), a wake-word engine 570, and at least one voice extractor 572, each of which is operably coupled to the voice processor 560. The NMD 503 further includes the microphones 222 and the at least one network interface 224 described above and may also include other components, such as audio amplifiers, interface, etc., which are not shown in FIG. 5 for purposes of clarity.

The microphones 222 of the NMD 503 are configured to provide detected sound, S_{D}, from the environment of the NMD 503 to the voice processor 560. The detected sound S_{D} may take the form of one or more analog or digital signals. In example implementations, the detected sound S_{D} may be composed of a plurality signals associated with respective channels 562 that are fed to the voice processor 560.

Each channel 562 may correspond to a particular microphone 222. For example, an NMD having six microphones may have six corresponding channels. Each channel of the detected sound S_{D} may bear certain similarities to the other channels but may differ in certain regards, which may be due to the position of the given channel's corresponding microphone relative to the microphones of other channels. For example, one or more of the channels of the detected sound S_{D} may have a greater signal to noise ratio (“SNR”) of speech to background noise than other channels.

As further shown in FIG. 5, the voice processor 560 includes an AEC 564, a spatial processor 566, and one or more buffers 568. In operation, the AEC 564 receives the detected sound SD and filters or otherwise processes the sound to suppress echoes and/or to otherwise improve the quality of the detected sound SD. That processed sound may then be passed to the spatial processor 566.

The spatial processor 566 is typically configured to analyze the detected sound S_{D} and identify certain characteristics, such as a sound's amplitude (e.g., decibel level), frequency spectrum, directionality, etc. In one respect, the spatial processor 566 may help filter or suppress ambient noise in the detected sound S_{D} from potential user speech based on similarities and differences in the constituent channels 562 of the detected sound S_{D}, as discussed above. As one possibility, the spatial processor 566 may monitor metrics that distinguish speech from other sounds. Such metrics can include, for example, energy within the speech band relative to background noise and entropy within the speech band—a measure of spectral structure—which is typically lower in speech than in most common background noise. In some implementations, the spatial processor 566 may be configured to determine a speech presence probability, examples of such functionality are disclosed in U.S. patent application Ser. No. 15/984,073, filed May 18, 2018, titled “Linear Filtering for Noise-Suppressed Speech Detection,” and U.S. patent application Ser. No. 16/147,710, filed Sep. 29, 2018, and titled “Linear Filtering for Noise-Suppressed Speech Detection via Multiple Network Microphone Devices,” each of which is incorporated herein by reference in its entirety.

The wake-word engine 570 is configured to monitor and analyze received audio to determine if any wake words are present in the audio. The wake-word engine 570 may analyze the received audio using a wake word detection algorithm. If the wake-word engine 570 detects a wake word, a network microphone device may process voice input contained in the received audio. Example wake word detection algorithms accept audio as input and provide an indication of whether a wake word is present in the audio. Many first-and third-party wake word detection algorithms are known and commercially available. For instance, operators of a voice service may make their algorithm available for use in third-party devices. Alternatively, an algorithm may be trained to detect certain wake-words.

In some embodiments, the wake-word engine 570 runs multiple wake word detection algorithms on the received audio simultaneously (or substantially simultaneously). As noted above, different voice services (e.g. AMAZON's Alexa®, APPLE's Siri®, MICROSOFT's Cortana®, GOOGLE'S Assistant, etc.) each use a different wake word for invoking their respective voice service. To support multiple services, the wake-word engine 570 may run the received audio through the wake word detection algorithm for each supported voice service in parallel. In such embodiments, the network microphone device 103 may include VAS selector components 574 configured to pass voice input to the appropriate voice assistant service. In other embodiments, the VAS selector components 574 may be omitted. In some embodiments, individual NMDs 103 of the MPS 100 may be configured to run different wake word detection algorithms associated with particular VASes. For example, the NMDs of playback devices 102a and 102b of the Living Room may be associated with AMAZON's ALEXA®, and be configured to run a corresponding wake word detection algorithm (e.g., configured to detect the wake word “Alexa” or other associated wake word), while the NMD of playback device 102f in the Kitchen may be associated with GOOGLE's Assistant, and be configured to run a corresponding wake word detection algorithm (e.g., configured to detect the wake word “OK, Google” or other associated wake word).

In some embodiments, a network microphone device may include speech processing components configured to further facilitate voice processing, such as by performing voice recognition trained to recognize a particular user or a particular set of users associated with a household. Voice recognition software may implement voice-processing algorithms that are tuned to specific voice profile(s).

In operation, the one or more buffers 568—one or more of which may be part of or separate from the memory 213 (FIG. 2A)—capture data corresponding to the detected sound Sp. More specifically, the one or more buffers 568 capture detected-sound data that was processed by the upstream AEC 564 and spatial processor 566.

In general, the detected-sound data form a digital representation (i.e., sound-data stream), S_{DS}, of the sound detected by the microphones 222. In practice, the sound-data stream S_{DS} may take a variety of forms. As one possibility, the sound-data stream S_{DS} may be composed of frames, each of which may include one or more sound samples. The frames may be streamed (i.e., read out) from the one or more buffers 568 for further processing by downstream components, such as the wake-word engine 570 and the voice extractor 572 of the NMD 503.

In some implementations, at least one buffer 568 captures detected-sound data utilizing a sliding window approach in which a given amount (i.e., a given window) of the most recently captured detected-sound data is retained in the at least one buffer 568 while older detected-sound data are overwritten when they fall outside of the window. For example, at least one buffer 568 may temporarily retain 20 frames of a sound specimen at given time, discard the oldest frame after an expiration time, and then capture a new frame, which is added to the 19 prior frames of the sound specimen.

In practice, when the sound-data stream S_{DS} is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, signal-to-noise ratio, microphone channel identification, and/or other information of the given sound specimen, among other examples. Thus, in some embodiments, a frame may include a portion of sound (e.g., one or more samples of a given sound specimen) and metadata regarding the portion of sound. In other embodiments, a frame may only include a portion of sound (e.g., one or more samples of a given sound specimen) or metadata regarding a portion of sound.

The voice processor 560 also includes at least one lookback buffer 569, which may be part of or separate from the memory 213 (FIG. 2A). In operation, the lookback buffer 569 can store sound metadata that is processed based on the detected-sound data S_{D} received from the microphones 222. In at least some embodiments, the sound metadata may be transmitted separately from the sound-data stream S_{DS}, as reflected in the arrow extending from the lookback buffer 569 to the network interface 224. For example, the sound metadata may be transmitted from the lookback buffer 569 to one or more remote computing devices separate from the VAS which receives the sound-data stream S_{DS}.

In any case, components of the NMD 503 downstream of the voice processor 560 may process the sound-data stream S_{DS}. For instance, the wake-word engine 570 can be configured to apply one or more identification algorithms to the sound-data stream S_{DS} (e.g., streamed sound frames) to spot potential wake words in the detected-sound S_{D}. When the wake-word engine 570 spots a potential wake word, the wake-word engine 570 can provide an indication of a “wake-word event” (also referred to as a “wake-word trigger”) to the voice extractor 572 in the form of signal S_{W}.

In response to the wake-word event (e.g., in response to a signal S_{W} from the wake-word engine 570 indicating the wake-word event), the NMD 503 can transition from the inactive state to the active state. As used herein, the “inactive state” refers to the state in which the NMD 503 captures and processes sound data to identify a wake word (e.g., via wake-word engine 570), but does not transmit data via a network interface to other devices for further processing. In this inactive state, the NMD 503 remains in a standby mode, ready to transition to an active state if a wake-word is detected, but not yet transmitting any data based on detected sound via a network interface.

In the active state, the voice extractor 572 receives and formats (e.g., packetizes) the sound-data stream S_{DS}. For instance, the voice extractor 572 packetizes the frames of the sound-data stream S_{DS} into messages. The voice extractor 572 transmits or streams these messages, M_{V}, that may contain voice input in real time or near real time to a remote VAS, such as the VAS 190 (FIG. 1B), via the network interface 224.

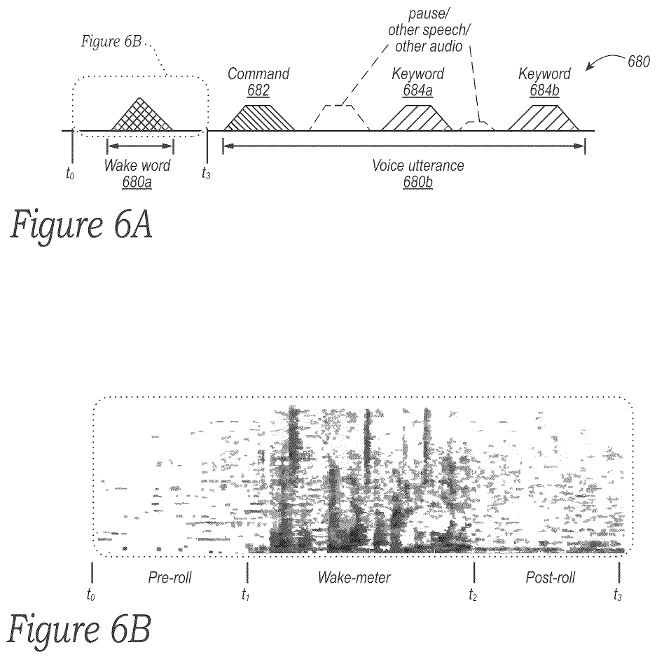

The VAS is configured to process the sound-data stream S_{DS} contained in the messages M_{V} sent from the NMD 503. More specifically, the VAS is configured to identify voice input based on the sound-data stream S_{DS}. Referring to FIG. 6A, a voice input 680 may include a wake-word portion 680a and an utterance portion 680b. The wake-word portion 680a corresponds to detected sound that caused the wake-word event. For instance, the wake-word portion 680a corresponds to detected sound that caused the wake-word engine 570 to provide an indication of a wake-word event to the voice extractor 572. The utterance portion 680b corresponds to detected sound that potentially comprises a user request following the wake-word portion 680a.

As an illustrative example, FIG. 6B shows an example first sound specimen. In this example, the sound specimen corresponds to the sound-data stream S_{DS} (e.g., one or more audio frames) associated with the spotted wake word 680a of FIG. 6A. As illustrated, the example first sound specimen comprises sound detected in the playback device 102i's environment (i) immediately before a wake word was spoken, which may be referred to as a pre-roll portion (between times to and t₁), (ii) while the wake word was spoken, which may be referred to as a wake-meter portion (between times t₁ and t₂), and/or (iii) after the wake word was spoken, which may be referred to as a post-roll portion (between times t₂ and t₃). Other sound specimens are also possible.

Typically, the VAS may first process the wake-word portion 680a within the sound-data stream S_{DS} to verify the presence of the wake word. In some instances, the VAS may determine that the wake-word portion 680a comprises a false wake word (e.g., the word “Election” when the word “Alexa” is the target wake word). In such an occurrence, the VAS may send a response to the NMD 503 (FIG. 5) with an indication for the NMD 503 to cease extraction of sound data (i.e., to transition from the active state back to the inactive state), which may cause the voice extractor 572 to cease further streaming of the detected-sound data to the VAS. The wake-word engine 570 may resume or continue monitoring sound specimens until another potential wake word, leading to another wake-word event. In some implementations, the VAS may not process or receive the wake-word portion 680a but instead processes only the utterance portion 680b.

In any case, the VAS processes the utterance portion 680b to identify the presence of any words in the detected-sound data and to determine an underlying intent from these words. The words may correspond to a certain command and certain keywords 684 (identified individually in FIG. 6A as a first keyword 684a and a second keyword 684 b). A keyword may be, for example, a word in the voice input 680 identifying a particular device or group in the MPS 100. For instance, in the illustrated example, the keywords 684 may be one or more words identifying one or more zones in which the music is to be played, such as the Living Room and the Dining Room (FIG. 1A).

To determine the intent of the words, the VAS is typically in communication with one or more databases associated with the VAS (not shown) and/or one or more databases (not shown) of the MPS 100. Such databases may store various user data, analytics, catalogs, and other information for natural language processing and/or other processing. In some implementations, such databases may be updated for adaptive learning and feedback for a neural network based on voice-input processing. In some cases, the utterance portion 680b may include additional information, such as detected pauses (e.g., periods of non-speech) between words spoken by a user, as shown in FIG. 6A. The pauses may demarcate the locations of separate commands, keywords, or other information spoke by the user within the utterance portion 680b.

Based on certain command criteria, the VAS may take actions as a result of identifying one or more commands in the voice input, such as the command 682. Command criteria may be based on the inclusion of certain keywords within the voice input, among other possibilities. Additionally, or alternatively, command criteria for commands may involve identification of one or more control-state and/or zone-state variables in conjunction with identification of one or more particular commands. Control-state variables may include, for example, indicators identifying a level of volume, a queue associated with one or more devices, and playback state, such as whether devices are playing a queue, paused, etc. Zone-state variables may include, for example, indicators identifying which, if any, zone players are grouped.

After processing the voice input, the VAS may send a response to the MPS 100 with an instruction to perform one or more actions based on an intent it determined from the voice input. For example, based on the voice input, the VAS may direct the MPS 100 to initiate playback on one or more of the playback devices 102, control one or more of these devices (e.g., raise/lower volume, group/ungroup devices, etc.), turn on/off certain smart devices, among other actions. After receiving the response from the VAS, the wake-word engine 570 the NMD 503 may resume or continue to monitor the sound-data stream S_{DS} until it spots another potential wake-word, as discussed above.

Referring back to FIG. 5, in multi-VAS implementations, the NMD 503 may include a VAS selector 574 (shown in dashed lines) that is generally configured to direct the voice extractor's extraction and transmission of the sound-data stream S_{DS} to the appropriate VAS when a given wake-word is identified by a particular wake-word engine, such as the first wake-word engine 570a, the second wake-word engine 570b, or the additional wake-word engine 571. In such implementations, the NMD 503 may include multiple, different wake-word engines and/or voice extractors, each supported by a particular VAS. Similar to the discussion above, each wake-word engine may be configured to receive as input the sound-data stream S_{DS} from the one or more buffers 568 and apply identification algorithms to cause a wake-word trigger for the appropriate VAS. Thus, as one example, the first wake-word engine 570a may be configured to identify the wake word “Alexa” and cause the NMD 503 to invoke the AMAZON VAS when “Alexa” is spotted. As another example, the second wake-word engine 570b may be configured to identify the wake word “Ok, Google” and cause the NMD 503 to invoke the GOOGLE VAS when “Ok, Google” is spotted. In single-VAS implementations, the VAS selector 574 may be omitted.

In additional or alternative implementations, the NMD 503 may include other voice-input identification engines 571 (shown in dashed lines) that enable the NMD 503 to operate without the assistance of a remote VAS. As an example, such an engine may identify in detected sound certain commands (e.g., “play,” “pause,” “turn on,” etc.) and/or certain keywords or phrases, such as the unique name assigned to a given playback device (e.g., “Bookcase,” “Patio,” “Office,” etc.). In response to identifying one or more of these commands, keywords, and/or phrases, the NMD 503 may communicate a signal (not shown in FIG. 5) that causes the audio processing components 216 (FIG. 2A) to perform one or more actions. For instance, when a user says “Hey Sonos, stop the music in the office,” the NMD 503 may communicate a signal to the office playback device 102n, either directly, or indirectly via one or more other devices of the MPS 100, which causes the office device 102n to stop audio playback. Reducing or eliminating the need for assistance from a remote VAS may reduce latency that might otherwise occur when processing voice input remotely. In some cases, the identification algorithms employed may be configured to identify commands that are spoken without a preceding wake word. For instance, in the example above, the NMD 503 may employ an identification algorithm that triggers an event to stop the music in the office without the user first saying “Hey Sonos” or another wake word.

### III. Example Systems and Methods for Maintaining Voice Assistant Persistence Across Multiple Network Microphone Devices

As noted above, in some cases an environment can contain multiple NMDs disposed in various locations. For example, a user may have a first NMD in the master bedroom, a second NMD on a living room shelf, and a third NMD in the den. In the case of extended voice interactions via an NMD (e.g., a multi-turn conversation with a VAS), it can be useful to coordinate among the various NMDs so that responsibility for detection, capture, and transmission of voice input as well as outputting responses to a user can be assigned to appropriate NMDs. For example, in some embodiments, one or more NMDs may detect a wake word in a captured voice input from a user. Upon detecting the wake word, some or all of these NMDs may transition from an inactive state (in which the NMD listens for a wake word in detected sound but does not transmit a voice utterance to a VAS or other device for processing) to an active state (in which the NMD captures voice input and transmits data to a VAS or other device for processing). In the active state, each NMD may proceed to transmit the voice utterance of the voice input to a VAS for processing, and may also continue to capture additional voice input.

As the user continues to interact with the VAS, the particular NMD designated to output responses from the VAS can vary. For example, while the user is positioned nearest to a first NMD in the master bedroom, a response from the VAS may be output only via the first NMD. Later, during the same conversation (e.g., a multi-turn conversation) or during a separate interaction with the VAS, the user may be positioned closer to the second NMD in the living room. Accordingly, at this later time, a response from the VAS may be output only via the second NMD. This process can continue dynamically, with the NMD responsible for outputting responses being selected based on user location, detected voice characteristics, other factors, or combinations of certain factors. In some embodiments, some or all of the NMDs can transition from the active state back to the inactive state after a predetermined time, for example a predetermined period of time after the last response output from that particular NMD, or after a predetermined time following the last response output from any of the NMDs. Accordingly, as described in more detail below, multiple NMDs may coordinate to provide the user experience of a persistent VAS interaction across multiple NMDs.

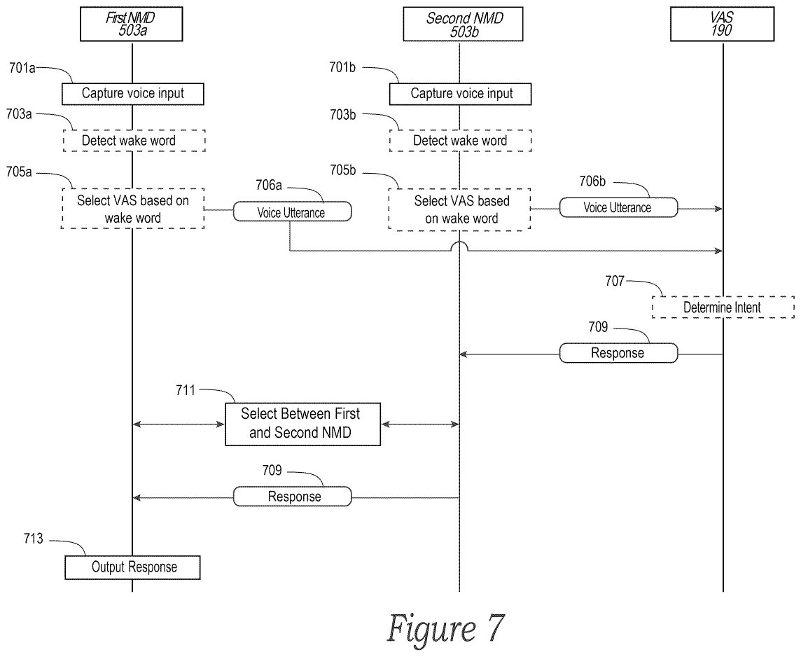

FIGS. 7-9 are signal line diagrams illustrating example data flows between a first NMD 503a, a second NMD 503b, and a VAS 190. Although only two NMDs are illustrated, the data flows described below can be generalized to any number of NMDs. Additionally, the data flows can be extended to additional VASes. Referring to FIG. 7, a first NMD 503a captures a voice input based on user speech (block 701a), detects a wake word in the voice input (block 703a), and optionally selects a VAS based on the wake word (block 705a) in the case of NMDs configured to interact with multiple VASes. The first NMD 503a then transmits a voice utterance 706a of the voice input to the VAS 190 for processing. These steps can be carried out as described above with respect to FIGS. 5-6B. In some embodiments, the voice utterance 706a can be transmitted via the network interface 224 (FIG. 5) of the first NMD 503a, for example over the LAN 111 or the WAN 107 (FIG. 1B). The first NMD 503a may concurrently transmit other information to the VAS 190 with the voice utterance 706a. For example, the first NMD 503a may transmit metadata, such as metadata associated with a state of a media playback state, as disclosed, for example, in previously referenced U.S. application Ser. No. 15/438,749.

A second NMD 503b may perform similar or identical steps in parallel to the first NMD 503a, for example capturing a voice input based on the same user speech (block 701b), detecting a wake word in the voice input (block 703b), optionally selecting a VAS based on the wake word (block 705b), and transmitting the voice utterance 706b to the VAS 190 for processing. In some embodiments, the first NMD 503a and the second NMD 503b may both be positioned within the vicinity of the user who provides the voice input. As such, each of the first NMD 503a and the second NMD 503b capture a voice input based on the same user speech. Because each NMD may be positioned differently with respect to the user, and/or may have different characteristics (e.g., different number of microphones, etc.), the particular sound data captured by each NMD may differ from one another.

In response to detecting the wake word in blocks 703a and 703b, the first and second NMDs 503a and 503b can each transition from the inactive state to the active state. As noted previously, in the inactive state, the NMD evaluates detected sound to identify a wake word (i.e., the occurrence of a wake-word event), but does not transmit sound data via a network interface to other devices for further processing. In this inactive state, the NMD 503 remains in a standby mode, ready to transition to an active state if a wake-word is detected, but not yet transmitting sound data based on detected sound via the network interface 224 (FIG. 5). In the active state, the NMD is enabled to extract the sound-data stream (as described above) and transmits or streams this data, which may contain voice input in real time or near real time, to the VAS 190 via the network interface 224.

In some embodiments, one or both of the NMDs 503a-b may provide an indication that the wake word has been detected and that the NMD has transitioned to an active state. For example, one or both of the NMDs 503a-b may illuminate a status light, change a color of a status light, pulse a status light, play back an audible indicator (e.g., a chime, a text-to-speech output, etc.), vibrate, or provide any other indicator to a user that the wake word has been detected by that particular NMD and that the NMD has transitioned from an inactive state to an active state.

In some embodiments, once an NMD (e.g., the first NMD 503a) transitions from the inactive state to the active state, a token or other state variable is generated locally on the NMD (or another device on the local area network 111) and indicates that the NMD is to maintain the active state for a predetermined time. While the token persists (e.g., up until the predetermined time has elapsed), the NMD may continue to capture voice input and, in some embodiments, continue to transmit sound data based on the captured voice input to the VAS 190 for processing. In some embodiments, the NMD transitions from the active state back to the inactive state after the predetermined time, and the token is updated, overwritten, or deleted from the NMD or other local device.

With continued reference to FIG. 7, the VAS 190 may process the voice utterances 706a and 706b received from the first and second NMDs 503a and 503b, respectively, to determine the user's intent (block 707). Based on the determined intent, the VAS 190 may send one or more response messages 709 (e.g., packets) to the second NMD 503b. In some instances, the response message(s) 709 from the VAS 190 may include a payload with a text-to-speech output or a voice response, such as information provided to a user, a request for more information (as in the case of multi-turn commands), or other suitable output. In addition or alternatively, the response message(s) 709 may include a payload that directs the second NMD 503b to execute instructions. For example, the instructions may direct the second NMD 503b to play back media content, group devices, and/or perform other functions.

In some embodiments, although both the first NMD 503a and the second NMD 503b captured voice input from the user, only one of the NMDs is selected (block 711) to output the response 709 from the VAS 190. In such embodiments, selection must be made between the first NMD 503a and the second NMD 503b, such that only one is assigned responsibility to output the response 709, and the other is not. In other embodiments, both of the NMDs 503a and 503b may output the response 709 in synchrony.

In the data flow illustrated in FIG. 7, the selection between the first NMD 503a and the second NMD 503b in block 711 occurs via coordination among the first NMD 503a and the second NMD 503b. For example, the first and second NMDs 503a-b can transmit one or more messages back and forth over a local area network regarding captured sound data, user location information, or any other relevant data to help determine which NMD will be assigned responsibility for outputting the response. In some embodiments, each NMD can exchange data and, based on the exchanged data, whichever NMD is determined to likely be nearer to the user is selected. In some embodiments, the particular NMD selected for outputting the response can be determined at least in part based on factors other than user location. For example, one NMD may be selected over another based upon device characteristics, specified user preference (e.g., a user may assign one NMD as “primary” or provide a ranking of preferred NMDs for output), current playback responsibilities (e.g., the first NMD 503a is currently playing back media content, while the second NMD 503b is not), etc.

In various embodiments, user location information can include or be based on any number of measured values, for example changing signal levels in captured voice input (e.g., increasing volume indicates a user is moving toward the NMD, while decreasing volume over time indicates a user is moving away from the NMD), changing acoustic signatures, detection of signal strength from a wireless proximity beacon (e.g., a Bluetooth low energy (BTLE) transmitter, near-field communication (NFC) transmitter, etc.), or any other suitable technique. For example, a user's smartphone, smartwatch, or other device may be outfitted with one or more wireless proximity beacons, allowing each NMD to independently sense a user's proximity as the user moves about the environment. In some embodiments, an NMD can be configured to emit an ultrasound signal and, based on the detected reflected ultrasound received at the NMD, determine a user's location, as described in U.S. patent application Ser. No. 16/149,992, entitled “Systems and Methods of User Localization,” which is hereby incorporated by reference in its entirety.

In the example data flow illustrated in FIG. 7, in the selection of block 711, the first NMD 503a is identified for outputting the response. For example, via communication between the first NMD 503a and the second NMD 503b, the user may be determined to be nearer to the first NMD 503a than to the second NMD 503b. In some embodiments, in response to the selection, the token or other local state variable associated with the selected NMD can be updated to reflect that the NMD is assigned responsibility to output the response 709 from the VAS 190. In some embodiments, this transition can be accompanied by an indication, for example illumination of a light, changing color of a light, pulsing a light, providing a chime or other sound, or any other suitable indicator that the NMD has been selected for outputting the response to the user.

Following the selection of block 711, the first NMD 503a forwards the response 709 to the first NMD 503a for output, for example transmitting the response 709 over a local area network. In block 713, the first NMD 503a outputs the response. For example, in the case of a voice output, the NMD 503a can play back the voice output to be heard by a user.

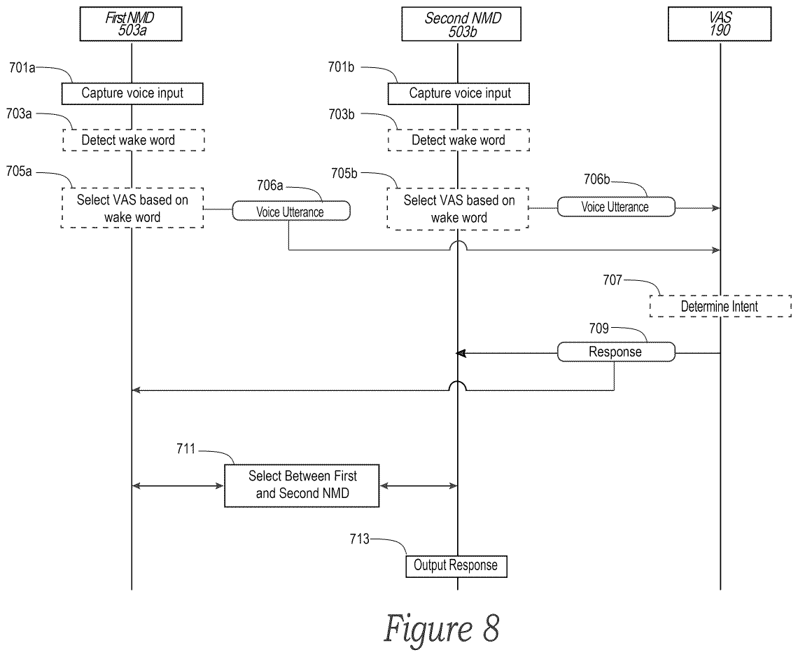

FIG. 8 illustrates another signal line diagram illustrating an example data flow between first and second NMDs 503a-b and a VAS 190. The data flow can initially be similar to that described above with respect to FIG. 7, including capturing voice input (blocks 701a-b), detecting a wake word (blocks 703-b), optionally selecting a VAS based on the wake word (blocks 705a-b), transmitting the voice utterances 706a-b to the VAS 190, and determining the user intent (block 707).

However, whereas in FIG. 7 the VAS 190 provided a response 709 only to the second NMD 503b, in the example of FIG. 8 the VAS 190 provides the response 709 to both the first NMD 503a and the second NMD 503b. The responses 709 can be transmitted to each NMD directly over a wide area network, or over a wide area network in combination with the local area network. The selection (block 711) of a particular NMD to output the response (block 713) can be performed as described above with respect to FIG. 7. However, in FIG. 8, each NMD has received the response from the VAS 190. Accordingly, once the selection has been made, there is no need to forward the response, regardless of which VAS is selected.

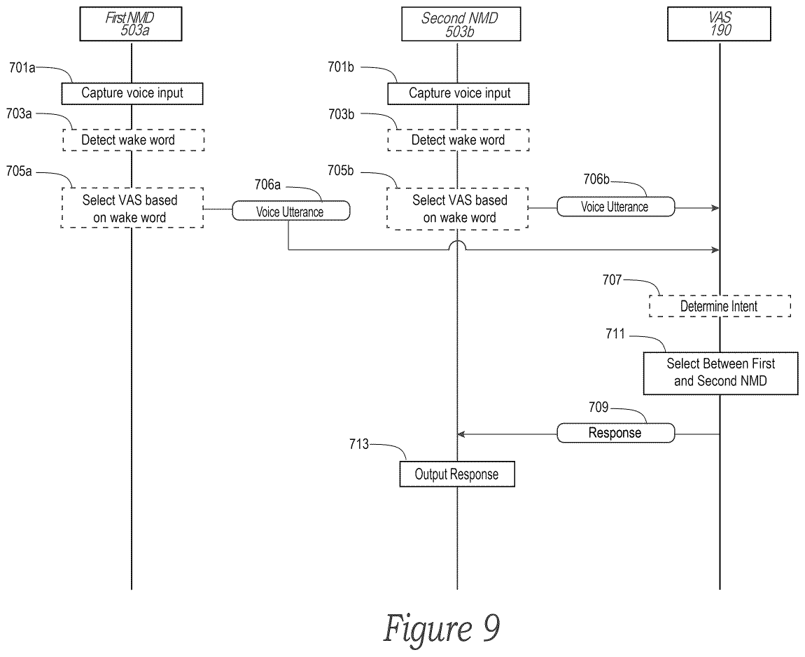

FIG. 9 illustrates a third signal line diagram illustrating an example data flow between first and second NMDs 503a-b and a VAS 190. The data flow can initially be similar to that described above with respect to FIGS. 7 and 8, including capturing voice input (blocks 701a-b), detecting a wake word (blocks 703-b), optionally selecting a VAS based on the wake word (blocks 705a-b), transmitting the voice utterances 706a-b to the VAS 190, and determining the user intent (block 707).

In contrast to the examples of FIGS. 7 and 8, in the example of FIG. 9 the selection (block 711) of the particular NMD to be assigned responsibility for outputting the response is performed at the VAS 190. In some embodiments, the VAS 190 selects between the possible NMDs based on data received from the NMDs 503a-b. For example, the NMDs 503a-b can transmit data to the VAS 190 as part of the voice utterance 706a-b or in addition to the voice utterances 706a-b. Such data can include, for example, user location information, signal levels in captured voice input, changing acoustic signatures, wireless proximity beacon signal levels, ultrasonic location tracking data, or any other data for the VAS 190 to select one NMD over another for outputting the response.

Once the VAS 190 has selected the second NMD 503b, the response 709 is transmitted only to the second NMD 503b. In block 713, the second NMD 503b then outputs the response (block 713), for example playing back a voice response received from the VAS 190.

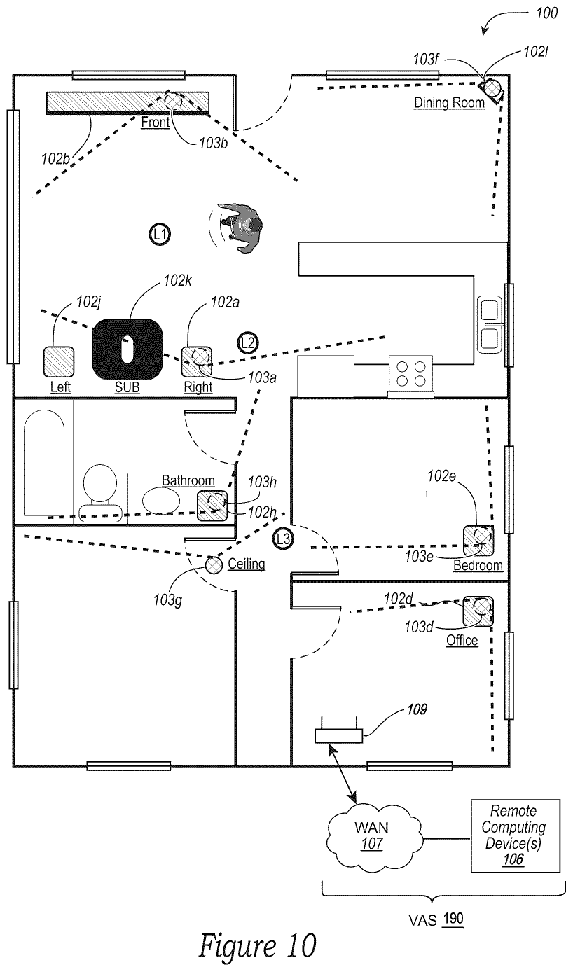

FIG. 10 is a schematic view of a user navigating an environment having a media playback system 100 configured in accordance with aspects of the disclosure. In the illustrated environment, a plurality of NMDs 103 are disposed about the environment. These NMDs are in communication with each other over a local area network (e.g., via the router 109 and wired and/or wireless connections (not shown)) and with remote computing devices 106 and a VAS 190 via the WAN 107, as described above with respect to FIGS. 1A and 1B. Because each NMD 103 is positioned in a different location, each will capture different sound data based on the same sound source. For example, a user's speech will be captured as different sound data in a first NMD that is positioned nearer to the user than in a second NMD that is further from the user. The dashed lines extending from each NMD schematically illustrate the area in which each NMD 103 is best positioned to capture voice input from a user.

Embodiments of the present technology enable a user to maintain an extended voice interaction even while moving about the environment by allowing the individual NMDs 103 to coordinate and hand-off responsibility for capturing voice input from the user and for outputting responses to the user. As one example, the user in location L1 may speak a wake word followed by a voice utterance (e.g., “Hey Sonos, play Stranger Things”). The right NMD 103a and the front NMD 103b may both detect the wake word event and transition into an active state. For example, each may generate a local token or other state variable indicating that these NMDs are to maintain the active state for a predetermined time. While the tokens persist (e.g., up until the predetermined time has elapsed), the NMDs 103a and 103b may continue to capture voice input and, in some embodiments, continue to transmit the captured voice input to the VAS 190 for processing. In some embodiments, additional nearby NMDs (e.g., dining room NMD 103f) may also be activated, even if those NMDs did not themselves detect the wake word.

A response from the VAS 190 can include a voice output (e.g., “Opening your recently viewed shows on Netflix”) to be output via only one of the NMDs 103. The media playback system 100 can select among the activated NMDs (e.g., between the right NMD 103a and the front NMD 103b). As described previously, this selection can be performed locally (e.g., the individual NMDs 103a and 103b may transmit data and determine which will be selected), remotely (e.g., the individual NMDs 103a and 103b can transmit data to the VAS 190 which can select one of the NMDs for output of the response), or some combination thereof. In some cases, the selection can be based at least in part on user location information (e.g., derived from sound levels, wireless proximity beacon signals, or other data). For example, if the user is facing toward the front NMD 103b when speaking, the front NMD 103b may detect higher signal levels in the voice input, and as such may be selected for outputting the response. If the front NMD 103b is selected, then the front NMD 103b provides the response (e.g., “Opening your recently viewed shows on Netflix”). In some instances, a status light, audible chime, or other indicator of the front NMD 103b may be initiated upon selection of the front NMD 103b to inform a user which NMD has been selected for output.

While the tokens persist and the right NMD 103a and the front NMD 103b remain in the active state, the media playback system 100 may monitor for user movement or other behavior. For example, the system 100 may detect changes to acoustic room signatures, collect data from wireless proximity beacon signals (e.g., Bluetooth® beacons), localize a user via ultrasonic reflection, etc. As an example, as the user moves from location L1 to location L2, the user moves further from the front NMD 103b and much closer to the right NMD 103a. Upon detecting this change, the system can update the tokens (or other state variables) to indicate that the right NMD 103a is now selected for outputting a response to the user. Optionally, a status light or other indicator can be initiated on the right NMD 103a to inform the user that the right NMD 103a has now been selected for outputting a response from the VAS to the user, and any status indicator on the front NMD 103b can be updated to indicate that the front NMD 103b is no longer providing output (e.g., a status light may be turned off). The right NMD 103a may then provide a further output to the user (e.g., “Would you like to continue watching season 2, episode 2?”).

In some embodiments, regardless of which NMD is selected for providing output, both the right NMD 103a and the front NMD 103b can maintain the active state, and so can both capture additional voice input and optionally transmit it to the VAS 190 for further processing. For example, in response to hearing the output from the right NMD 103a, the user may say “Yes.” The front NMD 103b may output a response from the VAS 190 (e.g., “Okay,” followed by playback of the requested Netflix® content). After expiry of a predetermined time, the token (or other state variables) may expire such that the right NMD 103a and the front NMD 103b are each transitioned from the active state back to the inactive state. These NMDs can remain in the inactive state until a wake word is detected.

If the user moves to the third location L3, the change may be detected by the media playback system 100 and one or more additional NMDs may be transitioned from the inactive state to the active state. For example, upon detecting a change in the user's location toward location L3, the media playback system 100 may activate the ceiling NMD 103g, even if the ceiling NMD 103g did not itself detect the wake word. If the user remains at that location, or if the ceiling NMD 103g captures voice input from the user, then the ceiling NMD 103g may be selected for outputting responses to the user. As such, the tokens or other state variables can be updated such that the right NMD 103a no longer has assigned responsibility for outputting a response to the user.

If, while at location L3, the user speaks the wake word and an utterance (e.g., “Hey Sonos, pause Netflix”), the voice input can be captured via the ceiling NMD 103g (and optionally may be captured by one or more other NMDs in the vicinity) and transmitted to the VAS 190. If the user then returns to location L2, the media playback system 100 may identify the change in location and update the tokens to indicate that the right NMD 103a is selected to output the response. Accordingly, a response from the VAS 190 (e.g., “would you like to resume watching Stranger Things?”) may be output via the right NMD 103a. In this example, the response from the VAS 190 is unsolicited but prompted based on context. In this instance, the user has paused media while leaving the living room area, and has since returned to the living room area. As such, the media playback system 100 may offer to resume media playback, even if unsolicited by the user.

As shown in this example, the user is able to continue the conversation with a VAS 190 across multiple NMDs (e.g., with voice input and response output being handled variously by the right NMD 103a, the front NMD 103b, and the ceiling NMD 103g). In some embodiments, this conversation can include multiple different NMDs without requiring the user to repeat the wake word when moving from the vicinity of one NMD to the vicinity of another NMD. In some instances, even when one NMD does not itself detect the wake word, that NMD may be transitioned to the active state and may participate in capturing voice input and outputting responses to the user, based at least in part on messages received from other NMDs indicating that a wake word has been detected.

These examples illustrate a few limited scenarios of coordinating output of responses among multiple NMDs while a user moves about an environment. Various other configurations and permutations are possible. For example, in some embodiments two or more NMDs may output a response in synchrony. In some embodiments, one or more NMDs that did not detect the wake word but are in the vicinity of the user (or in the vicinity of NMDs that did detect the wake word) may be transitioned to the active state for a predetermined time. In some embodiments, all activated NMDs can be configured to transition from the active state back to the inactive state simultaneously, while in other embodiments each NMD can have its own predetermined expiry period. For example, each NMD 103 may transition from the active state back to the inactive state after expiry of a predetermined period following the last response output by that particular NMD, or following the last captured voice input that meets certain threshold criteria (e.g., at least a certain volume level, etc.).

In some embodiments, when two or more NMDs are in the active state, one NMD may utilize sound data captured from microphones of another NMD to facilitate processing of voice input. For example, a first NMD may use sound data from its own microphones in addition to sound data captured by one or more microphones of a second NMD to process voice input from the user. By combining sound data from microphones of different NMDs, voice input can be more accurately captured, and environmental noise can be more effectively filtered. Additional details regarding utilizing sound data from a plurality of different NMDs for use in voice processing can be found in U.S. application Ser. No. 16/147,710, entitled “Linear Filtering for Noise-Suppressed Speech Detection Via Multiple Network Microphone Devices,” which is hereby incorporated by reference in its entirety.

As noted above, in some embodiments an NMD can be transitioned from the active state back to the inactive state after expiry of a predetermined time. For example, the predetermined time can be a length of time (e.g., 0.5 seconds, 1 second, 2 seconds, 5 seconds, 10 seconds, 30 seconds, 1 minute) from a particular event. The event may be, for example, the last response output from that particular NMD, the last voice input captured by that particular NMD, the last response output from any NMD in the environment, the last voice input captured by any NMD in that environment, or any other suitable event.

In some embodiments, the predetermined time can increase or decrease depending on the number of NMDs that detected the wake-word event in voice input from the user. For example, if only one NMD detects the wake word, the predetermined time may be 1 seconds, whereas if two or more NMDs detect the wake word, the predetermined time may be 5 seconds. Such a determination may occur, for example, in conjunction with the selection of the particular NMD for outputting a response, as described above with respect to block 711 of FIGS. 7-9.

In some embodiments, the predetermined time can be incremented when a conversation is determined to be ongoing. For example, multi-turn conversations between a user and a VAS can include a number of user voice inputs and a number of VAS responses output via one or more NMDs. In such instances, the predetermined amount of time can be increased incrementally with each further event in the conversation. For example, an additional 5 seconds may be added to the predetermined time (or the remaining predetermined time after some portion of the time has elapsed) each time an NMD outputs an additional response from the VAS. As another example, an additional 5 seconds may be added to the predetermined time (or the remaining predetermined time) each time another voice input is received via one or more NMDs and transmitted to the VAS for processing. As a result, some of all of the NMDs can maintain the active state for the duration of the multi-turn conversation, only returning to the inactive state after the conversation is determined to be concluded.

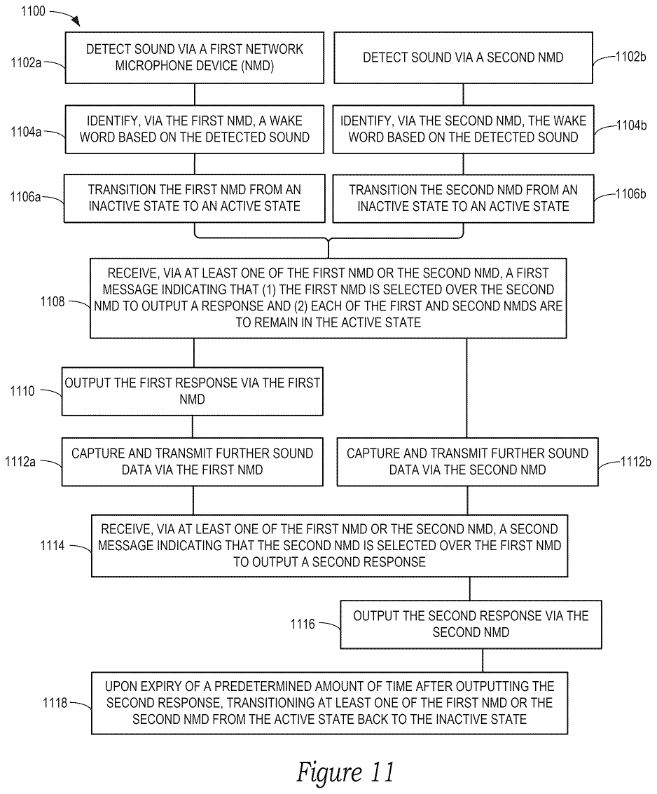

FIG. 11 is a flow diagram of a method 1100 for maintaining voice assistant persistence across multiple NMDs in accordance with aspects of the disclosure. Various embodiments of method 1100 include one or more operations, functions, and actions illustrated by blocks 1102 through 1118. Although some blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

The method 1100 begins at block 1102a with detecting sound via a first NMD, and the second NMD detecting sound in parallel in block 1102b. The detected sound can be, for example a voice input from a user that includes a wake word and a voice utterance such as a command, request, or other input. In blocks 1104a and 1104b, each of the first NMD and the second NMD, respectively, identifies a wake word based on the detected sound. After identifying the wake word, the first NMD and the second NMD can each capture and transmit over a network interface sound data corresponding to sound detected by the first NMD.

In response to detecting the wake word, in blocks 1106a and 1106b the first NMD and the second NMD each transition from an inactive state to an active state. As noted above, in at least some embodiments, in the inactive state the NMD only captures audio input sufficient to detect a wake word, for example storing only a small segment of audio in a local buffer (e.g., buffers 568 and/or lookback buffer 569 of FIG. 5) and continuously overwriting newly captured audio input until a wake word is detected. Upon detecting the wake word, the first NMD transitions to the active state, in which captured sound data is extracted and transmitted via a network interface, for example to another device on a local network or to a remote computing device associated with a VAS. In some embodiments, once the first NMD transitions to the activate state, an indicator can be initiated to reflect the change in state. For example, the first NMD may illuminate a status light, change the color or pulse of a light, emit a chime or other audible output, vibrate, or provide any other output to indicate the change in status. In other embodiments, the first NMD may provide no external indication of the change in status from an inactive state to an active state.

Next, the method 1100 advances to block 1108, with receiving, via at least one of the first NMD or the second NMD, a first message. The message can indicate that the first NMD is selected over the second NMD to output a response, and can also indicate that each of the first and second NMDs are to remain in the active state. In various embodiments, the message can be received (1) at the first NMD from the second NMD, (2) at the second NMD from the first NMD, (3) at the first or second NMD from another device on the local network, (4) at the first or second NMD from a remote VAS via a WAN, or any combination thereof. As indicated in the received message, the first NMD has been selected to output a response. As discussed above, this selection can be performed locally among the NMDs or other devices on a local network, on a remote computing device associated with a VAS, or some combination thereof. The selection can be based on user location information or other data relevant to selecting a particular NMD for outputting a response to the user's voice input.

In block 1110, the first NMD outputs the first response. For example, in the case of a voice output, the first NMD can play back the voice output to be heard by a user.

Next, in blocks 1112a and 1112b, the first NMD and the second NMD, respectively, capture and transmit further sound data. As noted in block 1108, each of the first NMD and the second NMD remain in the active state, and accordingly can continue to capture voice input from a user. For example, in the case of multi-turn conversations with a VAS, the NMDs can capture and transmit a further user input in response to the response output in block 1110.

The method 1100 continues in block 1114 with receiving, via at least one of the first NMD or the second NMD, a second message indicating that the second NMD is selected over the first NMD to output a second response. In block 1116, the second NMD outputs the second response (e.g., a voice output).

In various embodiments, the second message can be received (1) at the first NMD from the second NMD, (2) at the second NMD from the first NMD, (3) at the first or second NMD from another device on the local network, (4) at the first or second NMD from a remote VAS via a WAN, or any combination thereof. As discussed above with respect to block 1108, the selection predicating the second message can be performed locally or remotely, on a single device or via a plurality of devices working in concert. In some embodiments, the selection of the second NMD is based at least in part on user location. For example, if the user was previously determined to be closer to the first NMD, but has since moved closer to the second NMD, then the second NMD may be selected for outputting the second response, even though the first NMD was previously selected for output.

In block 1118, at least one of the first NMD or the second NMD is transitioned from an active state back to the inactive state following expiry of a predetermined amount of time after the second respond is output via the second NMD. For example, in some embodiments the second NMD can be transitioned back to the inactive state after a predetermined period of time (e.g., after more than 30 seconds, after more than 1 minute, etc.) following output of the second response. In some embodiments, each NMD that has been transitioned to the active state via detection of the wake word can be transitioned back to the inactive state substantially simultaneously. For example, any activated NMDs can be transitioned back to the inactive state after expiry of a predetermined time following the last output from any NMD. In other embodiments, at least one of the NMDs may be transitioned to the inactive state at a separate time from another NMD. For example, in some embodiments, each NMD can be transitioned back to the inactive state a predetermined time after that particular NMD has output a response, regardless of other responses output by other NMDs.

### Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A media playback system including at least a first network microphone device (NMD) and a second NMD, the media playback system comprising:
one or more processors; and
data storage having instructions stored thereon that, when executed by the one or more processors, cause the media playback system to perform operations comprising:
detecting, via the first NMD, a voice input from a user, the voice input comprising a wake word associated with a voice assistant service (VAS);
transitioning the first NMD from an inactive state to an active state in which the first NMD captures sound data and transmits the sound data over a network interface;
during a first portion of a multi-turn conversation between the user and the VAS, receiving a first response from the VAS and outputting the first response via the first NMD;
determining that the user has moved from a first location proximate the first NMD to a second location proximate the second NMD;
transitioning the second NMD to an active state in which the second NMD captures sound data and transmits the sound data over a network interface; and
during a second portion of the multi-turn conversation, capturing a subsequent voice input from the user via the second NMD and outputting a second response from the VAS via the second,
wherein the first portion and the second portion are part of a continuous conversational session with the VAS.

2. The media playback system of claim 1, wherein the operations further comprise, before transitioning the second NMD to the active state, detecting, via the second NMD, a second voice input from the user, the second voice input comprising a wake word associated with the VAS.

3. The media playback system of claim 1, wherein the determination that the user has moved from the first location to the second location is based on one or more of signal levels in captured voice input, changing acoustic signatures, wireless proximity beacon signal levels, or ultrasonic location tracking data.

4. The media playback system of claim 1, wherein the determination that the user has moved from the first location to the second location is based on:
identifying, via the first NMD, a decrease in volume in the voice input from the user, and
identifying, via the second NMD, an increase in volume in a second voice input from the user.

5. The media playback system of claim 1, wherein the operations further comprise forwarding the second response from the first NMD to the second NMD over a local area network.

6. The media playback system of claim 1, wherein the operations further comprise, after outputting the first response, transitioning the first NMD from the active state back to the inactive state after a predetermined time.

7. The media playback system of claim 6, wherein the operations further comprise:
receiving a determination that the user has moved from the second location back to the first location,
transitioning the first NMD from the inactive state to the active state, and
during a third portion of the multi-turn conversation, capturing additional voice input from the user via the first NMD and outputting a third response from the VAS via the first NMD based at least in part on a third determined location of the user.

8. A method performed by a media playback system comprising a first network microphone device (NMD) and a second NMD, the method comprising:
detecting, via the first NMD, a voice input from a user, the voice input comprising a wake word associated with a voice assistant service (VAS);
transitioning the first NMD from an inactive state to an active state in which the first NMD captures sound data and transmits the sound data over a network interface;
during a first portion of a multi-turn conversation between the user and the VAS, receiving a first response from the VAS and outputting the first response via the first NMD;
determining that the user has moved from a first location proximate the first NMD to a second location proximate the second NMD;
transitioning the second NMD to an active state in which the second NMD captures sound data and transmits the sound data over a network interface; and
during a second portion of the multi-turn conversation, capturing a subsequent voice input from the user via the second NMD and outputting a second response from the VAS via the second,
wherein the first portion and the second portion are part of a continuous conversational session with the VAS.

9. The method of claim 8, further comprising, before transitioning the second NMD to the active state, detecting, via the second NMD, a second voice input from the user, the second voice input comprising a wake word associated with the VAS.

10. The method of claim 8, wherein the determination that the user has moved from the first location to the second location is based on one or more of signal levels in captured voice input, changing acoustic signatures, wireless proximity beacon signal levels, or ultrasonic location tracking data.

11. The method of claim 8, wherein determining that the user has moved from the first location to the second location comprises:
identifying, via the first NMD, a decrease in volume in the voice input from the user, and identifying, via the second NMD, an increase in volume in a second voice input from the user.

12. The method of claim 8, further comprising forwarding the second response from the first NMD to the second NMD over a local area network.

13. The method of claim 8, further comprising, after outputting the first response, transitioning the first NMD from the active state back to the inactive state after a predetermined time.

14. The method of claim 13, further comprising:
determining that the user has moved from the second location back to the first location,
transitioning the first NMD from the inactive state to the active state, and
during a third portion of the multi-turn conversation, capturing additional voice input from the user via the first NMD and outputting a third response from the VAS via the first NMD based at least in part on a third determined location of the user.

15. One or more tangible, non-transitory, computer-readable media having stored therein instructions executable by one or more processors to cause a media playback system comprising first and second network microphone devices (NMDs) to perform operations comprising:
detecting, via the first NMD, a voice input from a user, the voice input comprising a wake word associated with a voice assistant service (VAS);
transitioning the first NMD from an inactive state to an active state in which the first NMD captures sound data and transmits the sound data over a network interface;
during a first portion of a multi-turn conversation between the user and the VAS, receiving a first response from the VAS and outputting the first response via the first NMD;
determining that the user has moved from a first location proximate the first NMD to a second location proximate the second NMD;
transitioning the second NMD to an active state in which the second NMD captures sound data and transmits the sound data over a network interface; and
during a second portion of the multi-turn conversation, capturing a subsequent voice input from the user via the second NMD and outputting a second response from the VAS via the second NMD,
wherein the first portion and the second portion are part of a continuous conversational session with the VAS.

16. The one or more computer-readable media of claim 15, the operations further comprising, before transitioning the second NMD to the active state, detecting, via the second NMD, a second voice input from the user, the second voice input comprising a wake word associated with the VAS.

17. The one or more computer-readable media of claim 15, wherein the determination that the user has moved from the first location to the second location is based on one or more of signal levels in captured voice input, changing acoustic signatures, wireless proximity beacon signal levels, or ultrasonic location tracking data.

18. The one or more computer-readable media of claim 15, wherein determining that the user has moved from the first location to the second location comprises:
identifying, via the first NMD, a decrease in volume in the voice input from the user, and
identifying, via the second NMD, an increase in volume in a second voice input from the user.

19. The one or more computer-readable media of claim 15, the operations further comprising forwarding the second response from the first NMD to the second NMD over a local area network.

20. The one or more computer-readable media of claim 15, the operations further comprising, after outputting the first response, transitioning the first NMD from the active state back to the inactive state after a predetermined time.
